(19) United States
(12) Patent Application Publication
(10) Pub. No.: US 2025/0370685 A1
(43) Pub. Date: Dec. 4, 2025

(54) INFORMATION PROCESSING SYSTEM, INFORMATION PROCESSING METHOD, AND STORAGE MEDIUM

(71) Applicant: CANON KABUSHIKI KAISHA, Tokyo (JP)

(72) Inventors: KOUKI YAMASHITA, Tokyo (JP); FUKASHI YAMAZAKI, Kanagawa (JP)

(21) Appl. No.: 19/224,448

(22) Filed: May 30, 2025

(30) Foreign Application Priority Data
Jun. 4, 2024 (JP) 2024-090550

(51) Int. Cl. G06F 3/14

(52) U.S. Cl. CPC G06F 3/14

(57) ABSTRACT

An information processing system that applies an image processing algorithm to image data includes a memory storing instructions, and at least one processor configured to execute the instructions to acquire input information from a user on the image data and information on the image processing algorithm, acquire an image processing algorithm corresponding to the input information and an image processing candidate being at least one of parameters constituting the image processing algorithm, by inputting a prompt based on the input information and the information on the image processing algorithm to a generative model based on deep learning, and display information on the image processing candidate on a display unit.

### BACKGROUND

### Field of the Disclosure

The disclosure herein relates to an information processing system, an information processing method, and a storage medium that allow a user to cause the system to stably execute desired image processing.

### Description of the Related Art

Techniques for generating an image desirable for a user by performing various types of image processing on image data have been known. Chenfei Wu, et al. “Visual ChatGPT: Talking, Drawing and Editing with Visual Foundation Models”, arXiv: 2303.04671v1 [cs.CV] discusses a technique by which a user inputs, for example, a name of predetermined image processing as a prompt to a generative model, which is a large-scale language model, and the generative model outputs a result of executing the predetermined image processing.

According to the technique discussed in Chenfei Wu, et al., image processing based on the prompt input by the user is automatically executed, and the result of executing the image processing is output. Therefore, depending on the accuracy of the generative model and the prompt provided by the user, there is a possibility that unintended image processing may be selected and executed.

### SUMMARY

The present disclosure is directed to providing an information processing system that displays an image processing candidate to a user based on input information from the user so that the user can cause the system to stably execute the desired image processing.

In addition, the present disclosure is also directed to achieving a function and an effect that are derived from each configuration represented in exemplary embodiments for implementing the technical disclosure described below and that cannot be obtained by conventional techniques.

According to an aspect of the present disclosure, an information processing system that applies an image processing algorithm to image data includes a memory storing instructions, and at least one processor configured to execute the instructions to acquire input information from a user on the image data and information on the image processing algorithm, acquire an image processing algorithm corresponding to the input information and an image processing candidate being at least one of parameters constituting the image processing algorithm, by inputting a prompt based on the input information and the information on the image processing algorithm to a generative model based on deep learning, and display information on the image processing candidate on a display unit.

Further features of the present disclosure will become apparent from the following description of exemplary embodiments with reference to the attached drawings.

### BRIEF DESCRIPTION OF THE DRAWINGS

FIG. 1 is a diagram illustrating an example of a functional configuration of an information processing system according to a first exemplary embodiment.

FIG. 2 is a diagram illustrating an example of a hardware configuration of the information processing system according to the first exemplary embodiment.

FIG. 3 is a diagram illustrating an example of a procedure of processing by the information processing system according to the first exemplary embodiment.

FIGS. 4A and 4B are diagrams illustrating examples of information on image processing algorithms that can be used in the information processing system according to the first exemplary embodiment.

FIG. 5 is a diagram illustrating an example of display in the information processing system according to the first exemplary embodiment.

FIG. 6 is a diagram illustrating an example of a functional configuration of an information processing system according to a second exemplary embodiment.

FIG. 7 is a diagram illustrating an example of a procedure of processing by the information processing system according to the second exemplary embodiment.

FIG. 8 is a diagram illustrating an example of display in the information processing system according to the second exemplary embodiment.

FIG. 9 is a diagram illustrating an example of a functional configuration of an information processing system according to a third exemplary embodiment.

FIG. 10 is a diagram illustrating an example of a procedure of processing by the information processing system according to the third exemplary embodiment.

FIG. 11 is a diagram illustrating an example of display in the information processing system according to the third exemplary embodiment.

### DESCRIPTION OF THE EMBODIMENTS

Hereinafter, exemplary embodiments of an information processing system disclosed in the present specification will be described with reference to the drawings. The same or equivalent components, members, and processes illustrated in the drawings are denoted by the same reference numerals, and redundant description thereof will be omitted as appropriate. In the drawings, some of the components, members, and processes are omitted as appropriate.

Hereinafter, the present disclosure will be described using, as an example of the information processing system, an information processing system that displays computed tomography (CT) image data captured by an X-ray CT device and a result of image processing performed on the CT image data. The exemplary embodiments of the present disclosure are not limited to the following exemplary embodiments, and the present disclosure can be applied to any images, including medical images such as images captured by a magnetic resonance imaging (MRI) device, a positron emission tomography (PET) device, and an ultrasonic diagnostic device.

An information processing system in a first exemplary embodiment is a system that can receive input information from a user, input the input information and information on an image processing algorithm into a generative model based on deep learning to acquire an image processing candidate and present the image processing candidate to the user.

The information processing system may further receive an acceptance or rejection from the user regarding whether to adopt the presented image processing candidate.

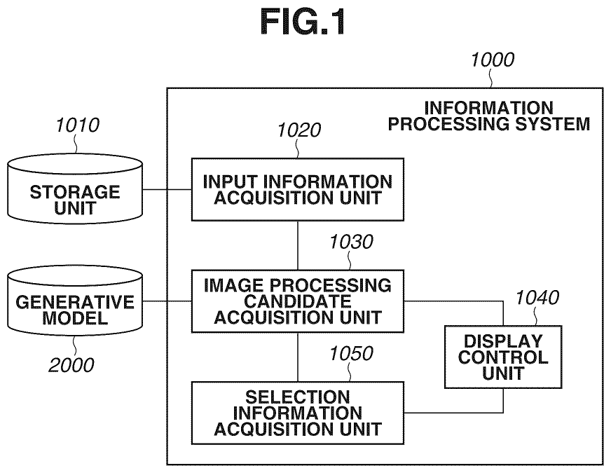

Hereinafter, a device configuration of an information processing system 1000 according to the present exemplary embodiment will be described with reference to FIG. 1.

The information processing system 1000 according to the present disclosure is an information processing system that applies an image processing algorithm to image data, and is configured to be connectable, via a network, to a storage unit 1010 that stores various data, and a deep learning-based generative model 2000.

The information processing system 1000 includes an input information acquisition unit 1020 that acquires user input information for image data and information on the image processing algorithm. The information processing system 1000 also includes an image processing candidate acquisition unit 1030 that inputs a prompt based on the input information and the information on the image processing algorithm to the deep learning-based generative model 2000. The image processing candidate acquisition unit 1030 acquires an image processing algorithm corresponding to the input information and an image processing candidate that is at least one of parameters constituting the image processing algorithm from the generative model 2000. The information processing system 1000 further includes a display control unit 1040 that displays information on the image processing candidate on a display unit. The information processing system 1000 may also include a selection information acquisition unit 1050 that acquires selection information for the image processing candidate displayed on the display unit.

Hereinafter, functional components constituting the information processing system 1000 will be described. The storage unit 1010 and the generative model 2000 may be implemented as the components of the system, or another device may constitute each functional component of the information processing system 1000 via a network or the like.

The storage unit 1010 is a part of a computer-readable storage medium, and is a large-capacity storage device typified by a hard disk drive (HDD) or a solid-state drive (SSD). The storage unit 1010 stores information on an image processing algorithm that can be used.

The input information acquisition unit 1020 acquires the user input information, and the information on the image processing algorithm from the storage unit 1010. The user input information is text information input by the user or text information selected by the user, and is a text prompt.

The image processing candidate acquisition unit 1030 inputs a prompt based on the user input information and the information on the image processing algorithm to the deep learning-based generative model 2000. Then, the image processing candidate acquisition unit 1030 acquires the image processing algorithm corresponding to the input information and an image processing candidate that is at least one of parameters constituting the image processing algorithm. The image processing candidate acquisition unit 1030 may acquire the image processing candidate by performing lexical analysis on answer text information acquired from the generative model 2000.

The display control unit 1040 causes the display unit to display the information on the image processing candidate acquired by the image processing candidate acquisition unit 1030.

The selection information acquisition unit 1050 receives a result of selection from a user with regard to the information on the image processing candidate, i.e., a determination (user's decision on application) on whether to apply the image processing corresponding to the information on the image processing candidate. In other words, the selection information acquisition unit 1050 acquires the acceptance or rejection of adopting the image processing candidate displayed on the display unit.

The information processing system 1000 is configured as described above so that the user can cause the system to stably execute desired image processing.

### Hardware Configuration

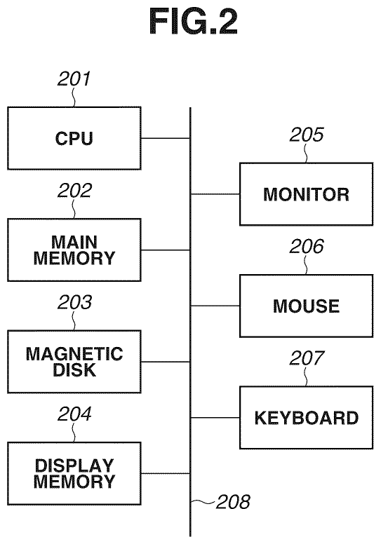

Next, a hardware configuration of the information processing system 1000 will be described with reference to FIG. 2. The information processing system 1000 has a configuration of a known computer (information processing system). The information processing system 1000 includes, as the hardware configuration thereof, a central processing unit (CPU) 201, a main memory 202, a magnetic disk 203, a display memory 204, a monitor 205, a mouse 206, and a keyboard 207.

The CPU 201 mainly controls operations of components. The main memory 202 stores control programs to be executed by the CPU 201 and provides a work area for the CPU 201 to execute the programs. The magnetic disk 203 stores programs for implementing various types of application software including an operating system (OS), drivers for peripheral devices, and programs for performing below-described processes and the like. When the CPU 201 executes the programs stored in the main memory 202, the magnetic disk 203, or the like, the functions (software) of the information processing system 1000 illustrated in FIG. 1 and processes in flowcharts described below are performed.

The magnetic disk 203 may be the same as the storage unit 1010.

The display memory 204 temporarily stores data for display. The monitor 205 is an example of a display unit, and includes a cathode ray tube (CRT) monitor or a liquid crystal monitor, for example, and displays images, text, and the like based on the data from the display memory 204. The mouse 206 and the keyboard 207 allow the user to perform pointing and input characters or the like, respectively. The above-described components are connected with each other via a common bus 208 so that they can communicate with each other.

The CPU 201 corresponds to an example of a processor or a control unit. The information processing system 1000 may have at least one of a graphics processing unit (GPU) and a field-programmable gate array (FPGA) in addition to the CPU 201. Alternatively, the information processing system 1000 may have at least one of the GPU and the FPGA instead of the CPU 201. The main memory 202 and the magnetic disk 203 correspond to an example of a memory or a storage device.

### Processing Procedure

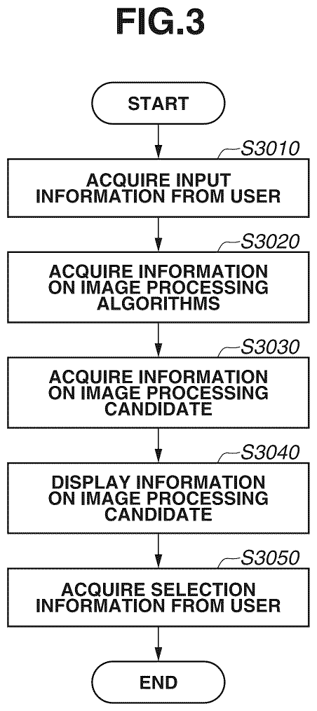

Next, a procedure of processing by the information processing system 1000 according to the present exemplary embodiment will be described with reference to FIG. 3.

### Step S3010

In step S3010, the input information acquisition unit 1020 acquires input information from the user. The input information here is text information that indicates details of processing desired by the user on the original image data. In the present exemplary embodiment, as an example, a case is described where a text prompt stating “I want to lower the detection threshold and perform a lesion detection process again” is acquired as the input information. This text prompt may be acquired as information input by the user using the mouse 206 or the keyboard 207 connected to the information processing system 1000. This text prompt may be acquired by converting information voice input by the user using a microphone (not illustrated) or the like into a text prompt using a known voice recognition technology. In addition, candidates for typical requests made by the user may be displayed on the monitor 205 so that the user can select from among the candidates using the mouse 206 or the keyboard 207. Examples of the candidates for the requests include “I want to increase the overall brightness of the image data” and “I want to reduce the blurring due to smoothing processing applied to the image data”.

### Step S3020

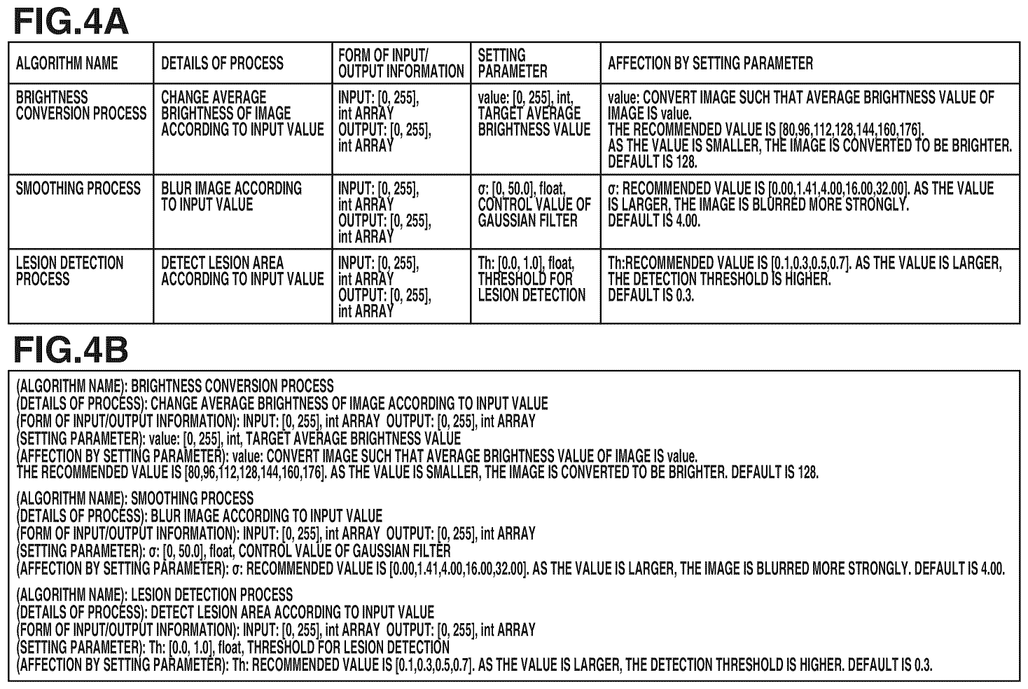

In step S3020, the input information acquisition unit 1020 further acquires information on image processing algorithms that can be used in the information processing system 1000 from the storage unit 1010. In the present exemplary embodiment, as examples of the image processing algorithms that can be used, a smoothing process, a brightness adjustment process, and a lesion detection process are described. The information acquired here includes, for each image processing algorithm, an algorithm name, processing details, a form of input/output information, a name of a parameter that can be set, and an effect of changing the parameter. In the present exemplary embodiment, text information including these pieces of information is acquired. FIG. 4A illustrates an example of the information on the image processing algorithms, and FIG. 4B illustrates an example of the text information actually acquired by the input information acquisition unit 1020. However, the information processing system 1000 may execute the processes in a state where these pieces of information are stored in advance in the main memory 202 or the like, in which case execution of this step can be omitted. The input information acquisition unit 1020 transmits the user input information and the information on the image processing algorithms to the image processing candidate acquisition unit 1030, and the processing proceeds to the next step.

### Step S3030

In step 3030, the image processing candidate acquisition unit 1030 generates an extended text prompt, which is a prompt for the generative model, based on a text prompt, which is the user input information, and the information on the image processing algorithms that can be used. The image processing candidate acquisition unit 1030 then inputs the extended text prompt to the generative model 2000 and acquires answer text information including information on an image processing candidate.

A configuration of the generative model will be described here. The generative model in the present exemplary embodiment is a model with Transformer at its core, and consists of processing blocks such as a Tokenization block, an Embeddings block, a Positional Encoding block, a Transformer block, and a Decoding block. In the generative model, first, in the Tokenization block, the input text prompt is processed to divide the text prompt into tokens, such as words and phrases, to acquire a group of tokens corresponding to the text prompt. Each token is associated with an ID (numerical data). Division into tokens is implemented by a known technique, such as a Byte-Pair Encoding algorithm. Next, in the Embeddings block, each token is converted into a vector representation (Embedding vector) so that the model can easily understand the meaning. In an Embedding space, for example, tokens that are semantically close are mapped to close positions. Conversion into the vector representation is implemented by a trained Embedding layer. Next, in the Positional Encoding block, information on positional relationship between tokens is added to the Embedding vector corresponding to each token so that the positional relationship between the tokens can be taken into account in the subsequent Transformer block. More specifically, a position vector expressing the position of the token in the text prompt is added to the Embedding vector to obtain a position-encoded Embedding vector. Next, in the Transformer block, the position- encoded Embedding vector is processed using an Attention mechanism or the like to convert the position-encoded Embedding vector into an abstract representation while capturing the association and context between the tokens, and predict tokens related to output. Then, the predicted tokens are combined with the group of tokens corresponding to the text prompt that is input, thereby generating new input data, and the above-described processing is repeated. When a token indicating the end of a sentence is output, finally, in the Decoding block, the output group of tokens is converted into text (de-tokenization) or shaped into human-understandable text. The above-described generative model uses large-scale text data and is trained using a known method such as Masked Language Modeling, so that the generative model can generate answer text to a text prompt (question text). The generative model may be any model with any configuration, processing procedure, or learning method, as long as the model is capable of generating answer text to a text prompt.

Next, the extended text prompt generated by the image processing candidate acquisition unit 1030 and the output of the generative model will be described in detail. In the present exemplary embodiment, an extended text prompt is generated by inserting a text prompt and information on the image processing algorithms that can be used into a prompt template. The prompt template is a sentence as described below, for example, and may be set in advance: “Propose a process that satisfies the input information based on the following information on the image processing algorithm. Information on the image processing algorithm: {(A)}, input information: {(B)}. The output format is the following: ‘{image processing algorithm name}: {parameter}’”.

Text information on the image processing algorithm acquired by the input information acquisition unit 1020 is inserted into (A) in the prompt template. Also, input information acquired by the input information acquisition unit 1020 is inserted into (B).

The image processing candidate acquisition unit 1030 generates the extended text prompt as described above, inputs the extended text prompt to the generative model 2000 for processing, thereby acquiring answer text information stating “Lesion detection processing: Th=0.3” from the generative model 2000, for example. The “Lesion detection processing” in the answer text information example is the name of an image processing algorithm included in the information on the image processing algorithms inserted into (A) in the extended text prompt, and is one of the image processing algorithms that can be used by the information processing system 1000.

The image processing candidate acquisition unit 1030 acquires information on the image processing candidate from the answer text information. The information on the image processing candidate here refers to a set of the name of an image processing algorithm and a parameter related to the image processing algorithm for implementing the desired processing details expressed by the user in the text prompt (input information) on the information processing system 1000. The image processing candidate acquisition unit 1030 performs lexical analysis on the answer text information stating “Lesion detection processing: Th=0.3” acquired in step S3050, and extracts the image processing algorithm name (lesion detection processing) and the parameter (Th=0.3) by separating the answer text information with the character “:”. Then, based on an extracted result, the image processing algorithm name and the parameter related to image processing that can be implemented by the information processing system 1000 are acquired as the information on the image processing candidate, and the information is transmitted to the display control unit 1040, and the process proceeds to the next step.

### Step 3040

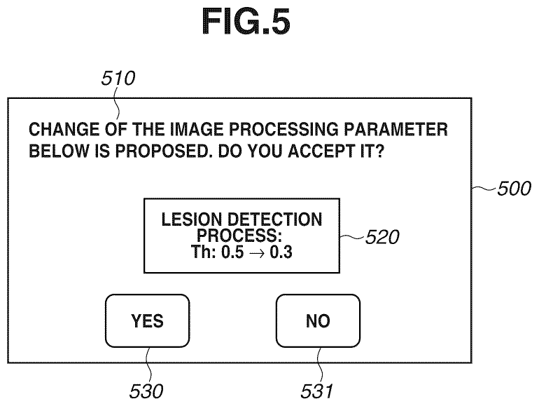

The display control unit 1040 displays information on the image processing candidate on the monitor 205 that is the display unit. FIG. 5 illustrates an example of the display. An information display window 500 displayed on the display unit by the display control unit 1040 includes a proposal text 510, a proposal content 520, and selection buttons 530 and 531. The proposal text 510 is a fixed text that requests the user to make a determination on application to the image processing candidate. The proposal content 520 is a text generated based on the information on the image processing candidate, and in the present exemplary embodiment, a text expressing a difference in information on image processing is displayed. More specifically, the text is set to indicate a proposal to change the default parameter Th of the lesion detection processing from 0.5 to 0.3. A method of presenting the proposal text 510 is not limited to displaying text on the monitor, and may be performed by other means such as text reading.

### Step S3050

The selection information acquisition unit 1050 receives information on the result of selection by the user. If the selection button 530 indicating affirmative is pressed, the selection information acquisition unit 1050 determines that the proposal content 520 about the image processing candidate is accepted, and if the selection button 531 indicating negative is pressed, the selection information acquisition unit 1050 determines that the proposal content 520 is rejected. In other words, the user's acceptance or rejection of the image processing candidate is determined based on which selection button has been pressed. The information on the result of selection may be received by other means, such as voice input. The information processing system 1000 determines the processing details and parameter to be applied based on the user's selection.

If the proposal content 520 is accepted in step S3050, a setting value of the parameter for the image processing corresponding to the information on the image processing candidate is changed to the proposed parameter value. The display control unit 1040 may render an obtained image processing result on the monitor 205.

In the present exemplary embodiment, the lesion detection process with the parameter Th changed to 0.3 is applied to the original image data, and lesion detection result data after the parameter change is acquired and rendered on the monitor 205.

The current image data is CT image data, for example. If rejected, a message prompting the user to make a re-proposal of the parameter may be rendered on the monitor 205. For example, a method in which a message stating “Do you want to set a value other than 0.3 for the parameter Th? If so, please enter a specific numerical value” is rendered may be considered. Alternatively, a message prompting the user to re-enter the text prompt may be rendered on the monitor 205. If the user wants to re-enter the text prompt, the processing returns to step S3010.

Through the above processing procedure, the information processing system 1000 can identify information on the image processing candidate desired by the user by processing the text prompt indicating the image processing details desired by the user and the information on the image processing algorithm using a generative model.

### System for Acquiring Preliminary Image Processing Information (Information on Preliminary Image Processing)

An information processing system 6000 in a second exemplary embodiment further uses information on preliminary image processing for display on a display control unit 6040 and for acquisition of an image processing candidate by an image processing candidate acquisition unit 6030. The configuration makes it possible to identify the image processing candidate desired by a user and stably execute the image processing desired by the user while saving the user's time and effort. The same functional components as those in the first exemplary embodiment are given the same reference numbers, and description thereof will be omitted as appropriate.

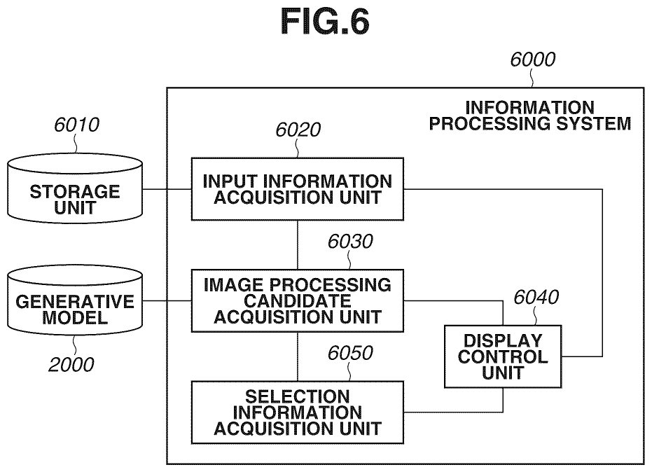

Hereinafter, a functional configuration of the information processing system 6000 according to the present exemplary embodiment will be described with reference to FIG. 6.

A storage unit 6010 is a part of a computer-readable storage medium, and is a large-capacity storage device typified by an HDD or an SSD. The storage unit 1010 holds original image data (an example of second image data) and preliminary image processing result data (an example of first image data) that is a result of applying any image processing to the original image data by a previous operation by the user. The storage unit 6010 further holds information on image processing algorithms that can be used, and a history of preliminary image processing that has previously been applied to the original image data (or preliminary image processing data).

An input information acquisition unit 6020 acquires input information from the user, information on the image processing algorithms from the storage unit 6010, and information on preliminary image processing.

The image processing candidate acquisition unit 6030 further inputs the information on preliminary image processing to a generative model 2000 to acquire an image processing candidate.

The display control unit 6040 displays the information on the image processing candidate acquired from the image processing candidate acquisition unit 6030. Alternatively, the display control unit 6040 causes the display unit to display information on the preliminary image processing and the information on the image processing candidate.

### Processing Procedure

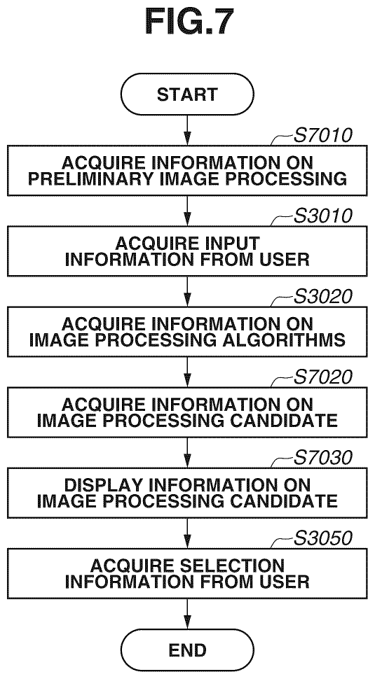

Next, a procedure of processing by the information processing system 6000 according to the present exemplary embodiment will be described with reference to FIG. 7. When the information processing system 6000 starts processing, the processing first proceeds to step S7010.

### Step S7010

In step S7010, the input information acquisition unit 6020 acquires the original image data to be processed and the preliminary image processing result data that is the result of any image processing applied to the original image data by a previous operation by the user. In addition, a preliminary image processing information acquisition unit 1080 acquires information on a history of image processing that has previously been applied to image data (information on preliminary image processing).

In the present exemplary embodiment, the original image data is CT image data (an example of first image data), and the preliminary image processing result data is lesion detection result data (an example of second image data) that represents a result of lesion detection.

For example, if the preliminary image processing is a lesion detection process, the preliminary image processing result data is image data in which a lesion area is expressed to be distinguishable from other areas. In the image data, pixel (voxel) values of pixels (voxels) belonging to a lesion area are expressed as 1, and pixel (voxel) values of other pixels (voxels) are expressed as 0, for example. The preliminary image processing result data such as the lesion detection result data is not limited to image data, and may be data other than image data, such as coordinate information and labels. The display control unit 6040 may display the CT image data that is the original image data and the lesion detection result data that is the preliminary image processing result data on the monitor 205.

### Steps S3010 to S3020

Steps S3010 and S3020 executed by the input information acquisition unit 6020 are similar to those in the first exemplary embodiment, and therefore description thereof will be omitted.

### Step S7020

The image processing candidate acquisition unit 6030 acquires the information on preliminary image processing, a text prompt indicating details of desired processing on the image data, and information on image processing algorithms that can be used. The image processing candidate acquisition unit 6030 generates an extended text prompt that is an input to the generative model 2000 by inserting the text prompt and the information on the image processing algorithms. The prompt template is a sentence as described below, for example: “Propose a process that satisfies the input information based on the following information on the image processing algorithm. Information on the image processing algorithm: {(A)}, input information: {(B)}, preliminary image processing: {(C)}. The output format is the following: “{image processing algorithm name}: {parameter}””. Text information on the image processing algorithm is inserted into (A) in the prompt template. The input information from the user is inserted into (B). The information on the preliminary image processing acquired in step S7010 is inserted into (C). The information on the preliminary image processing is a set of an image processing algorithm name and a parameter related to the image processing algorithm that has been previously applied to image data such as the original image data and the preliminary image processing data. In the present exemplary embodiment, the information on the image processing algorithm that is applied to the image data most recently is acquired from the history. As a specific example, a case will be described in which a history indicating that a lesion detection process has been applied to original image data with a parameter Th=0.5 is acquired as the information on the preliminary image processing.

### Step S7030

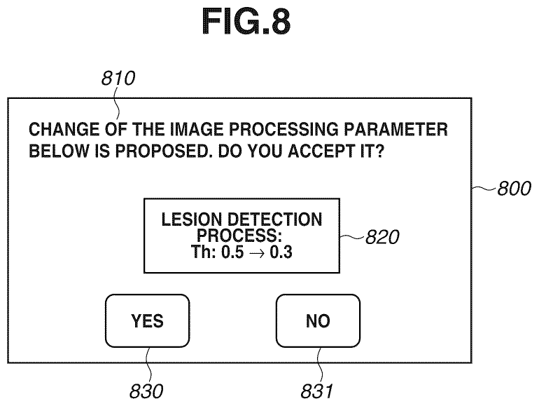

In step S7030, the display control unit 6040 generates drawing contents based on the information on the image processing candidate and the information on the preliminary image processing, and renders the drawing contents on the monitor 205. FIG. 8 illustrates an example of display. An information display window 800 includes a proposal text 810, a proposal content 820, and selection buttons 830 and 831. The proposal text 810 is a fixed text that requests the user to make a determination on application to the image processing candidate. The proposal content 820 is a text generated based on the information on the preliminary image processing and the information on the image processing candidate, and in the present exemplary embodiment, a text expressing a difference in the information on image processing is displayed. More specifically, the image processing algorithm corresponding to the information on the preliminary image processing and the image processing algorithm corresponding to the information on the image processing candidate are different only in parameter. Therefore, a text indicating a proposal to change the parameter Th of the lesion detection processing from 0.5 to 0.3 is set. The method of presenting the proposal text 810 is not limited to displaying text on the monitor, and may be performed by other means such as text reading.

### Step S3050

Step S3050 is similar to that in the first exemplary embodiment, and therefore description thereof will be omitted.

Through the above processing procedure, the information processing system 6000 can identify the information on the image processing candidate desired by the user with higher accuracy by using the information on the preliminary image processing.

### Modifications

In the first and second exemplary embodiments, the example in which the user wants to adjust the threshold for lesion detection in image data and inputs a text prompt is described. However, a configuration in which the information processing system automatically proposes a prompt by performing image analysis on image data such as original image data or preliminary image processing result data may be employed.

For example, the information on image processing may be the entire text of a manual or instructions for the information processing system, or a prompt may be generated by extracting relevant text from the manual or instructions using a known technique such as retrieval-augmented generation (RAG) and inserting the extracted text into a prompt template.

The above examples of the information on image processing algorithms that can be used and the above examples of input to and output from the generative model are merely examples, and appropriate formats may be used depending on the system.

The format of information input to the generative model is not limited to text, and may be data converted into a feature amount used in the generative model (such as IDs or Embedding vectors corresponding to tokens). Further, image data or audio data may be input as a prompt, or these may be used in combination with text. In such cases, the generative model needs to be configured to support multimodal input.

The generative model can also be trained to be able to provide information on image processing algorithms. In that case, the input information from the user can be used as is.

In the first and second exemplary embodiments, the example in which the setting value of a parameter for image processing is changed is described. However, in addition to changing the setting value for a parameter, a proposal regarding a change in a model used in an image processing algorithm may be made, or a proposal regarding an image processing algorithm itself may be made.

A specific example of making the proposal for changing a model used in an image processing algorithm will be described. For example, it is assumed that an information processing system receives a text prompt stating “I want to increase the detection sensitivity of lesions” from a user. The information processing system generates input data (extended text prompt) for the generative model 2000 by a procedure similar to those of the above exemplary embodiments. At this time, the information on image processing in the input data includes the names and parameters of image processing algorithms available to the information processing system, and information on available models (for example, characteristics, training data, training methods, and the like of each of a plurality of deep learning models). The information processing system inputs input data including such information into the generative model 2000 and executes a series of processes for the generative model to obtain answer text information. Then, the information processing system compares the answer text information with information on lexical analysis and preliminary image processing, and makes a proposal to the user stating, “Image processing algorithm X: change model A to model B”, for example. A specific example of making a proposal regarding the image processing algorithm itself will be described. For example, it is assumed that the information processing system receives a text prompt stating, “I want to blur the image” from a user. The information processing system generates input data for the generative model by a procedure similar to those of the above exemplary embodiments, and executes a series of processes for the generative model to obtain answer text information. Then, from the answer text information, the information processing system acquires the name of an image processing algorithm such as “Gaussian filter processing” as information on the image processing candidate.

In each of the first and second exemplary embodiments, the image processing candidate acquisition unit acquires the answer text information on one image processing candidate. However, the present disclosure is not limited to this, and answer text information including a plurality of image processing candidates may be acquired.

Specifically, the answer text information on the plurality of image processing candidates can be acquired by inserting text such as “Propose three processes in order of priority for output” into an extended text prompt to be input to the generative model. In this case, each of the plurality of image processing candidates included in the acquired answer text information can be displayed in a manner that allows the user to compare them. Then, as processing in step S3050, the user may be allowed to select a suitable image processing candidate from the above three image processing candidates. This has an effect of allowing the user to acquire the desired image processing candidate with a high probability.

In the first and second exemplary embodiments, as the processing by the information processing system, an example is described where, when the image processing candidate is rejected by the user, the user is prompted to perform re-proposal of a parameter or re-input of a text prompt. However, the present disclosure is not limited to this. For example, when the image processing candidate is rejected by the user, the processing may be returned to step S3020, and an extended text prompt may be generated to cause the generative model to propose image processing other than the already proposed image processing candidate. Specifically, a prompt stating “Output a candidate other than ‘lesion detection processing: Th=0.3’” is generated, and the processing is executed. This has an effect of allowing the user to acquire the desired image processing candidate with a higher probability, as in the above-described example.

In the first and second exemplary embodiments, the information processing system identifies information on an image processing candidate, such as the name of an image processing algorithm and the parameter, to obtain a result desired by the user, based on a prompt input by the user. Then, the information processing system proposes, to the user, changing the setting value of the parameter based on the information on the image processing candidate, and receives an acceptance or rejection (decision on application) of a proposal content from the user, thereby determining whether to adopt the proposal content such as the change of the parameter setting value.

In a third exemplary embodiment, after identifying the information on image processing candidate in the same procedure as that in the first or second exemplary embodiment, an image processing unit applies image processing corresponding to the information on the image processing candidate to original image data, and presents a resultant image to the user. Then, the user's acceptance or rejection (decision on application) of the resultant image is received from the user, and it is determined whether to adopt the image processing based on the decision on application.

### Functional Configuration

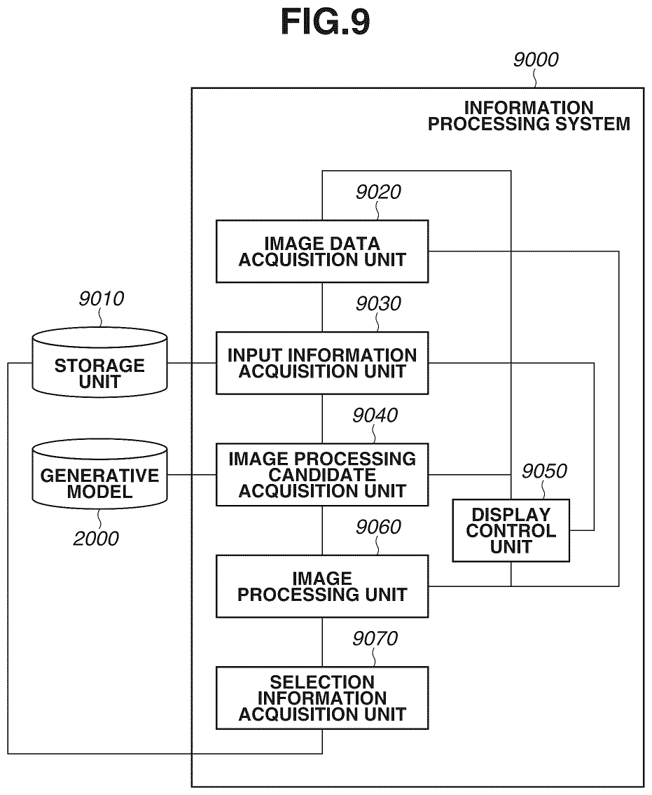

Hereinafter, a device configuration of an information processing system 9000 according to the present exemplary embodiment will be described with reference to FIG. 9.

A storage unit 9010 is a part of a computer-readable storage medium, and is a large-capacity storage device typified by an HDD or an SSD. The storage unit 9010 holds original image data (an example of second image data) and preliminary image processing result data (an example of first image data) that is a result of applying any image processing to the original image data by a previous operation by the user. The storage unit 9010 further holds information on image processing algorithms that can be used on the information processing system 9000.

An image data acquisition unit 9020 acquires the original image data and the preliminary image processing result data from the storage unit 9010.

A display control unit 9050 displays, on the display unit, image data such as the original image data and the preliminary image processing result data, instruction text for the user, and selection buttons for receiving selection from the user.

An input information acquisition unit 9030 acquires details of image processing desired by the user as a text prompt input by the user, and further acquires information on the image processing algorithms.

An image processing candidate acquisition unit 9040 acquires information on image processing that can be used by the information processing system 6000.

The image processing candidate acquisition unit 9040 inputs a text prompt including the input information acquired by the input information acquisition unit 9030 and information on image processing to a generative model 2000. Then, the image processing candidate acquisition unit 9040 acquires answer text information including image processing and information on the image processing through processing by the generative model 2000.

The image processing candidate acquisition unit 9040 performs lexical analysis on the answer text information acquired from the generative model 2000, and acquires information on the image processing candidate.

An image processing unit 9060 applies the image processing corresponding to the information on the image processing candidate acquired by the image processing candidate acquisition unit 9040 to the original image data acquired by the image data acquisition unit 9020. Then, the image processing unit 9060 acquires subsequent image processing result data (an example of third image data) that is a result of the image processing.

The display control unit 9050 generates comparison image data between the preliminary image processing result data and the subsequent image processing result data, and displays the comparison image data on the display unit.

A selection information acquisition unit 9070 receives a determination (user's decision on application) on whether to apply the image processing corresponding to the information on the image processing candidate displayed on the display unit. Based on user's selection information received by the selection information acquisition unit 9070, the information processing system 9000 determines the image processing to be applied to the original image data and the preliminary image processing result data.

### Hardware Configuration

Since a configuration according to the present exemplary embodiment is similar to that according to the first exemplary embodiment, description thereof will be omitted.

### Processing Procedure

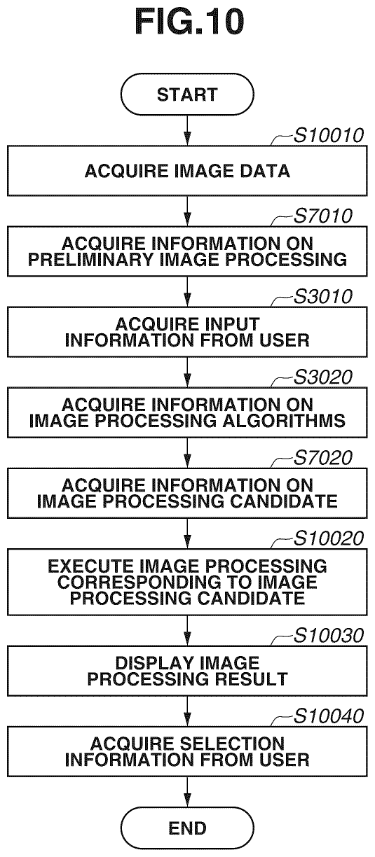

Next, a procedure of processing by the information processing system 9000 according to the present exemplary embodiment will be described with reference to FIG. 10. When the information processing system 9000 starts processing, the processing first proceeds to step S10010.

### Step S10010

The image data acquisition unit 9020 acquires the original image data and the preliminary image processing result data from the storage unit 9010.

### Steps S7010 to S7020

Since these steps are similar to steps S7010 to S7020 in the second exemplary embodiment, description thereof will be omitted.

### Step S10020

In step S10020, the image processing unit 9060 acquires subsequent image processing result data by applying the image processing corresponding to the information on the image processing candidate acquired from the image processing candidate acquisition unit 9040 to the original image data acquired in step S10010. In the present exemplary embodiment, the image processing unit 9060 acquires lesion detection result data after the parameter change (an example of third image data), which is the subsequent image processing result data, by applying lesion detection processing with the parameter Th changed to 0.3 to the CT image data, which is the original image data.

### Step S10030

In step S10030, the display control unit 9050 compares the preliminary image processing result data (an example of first image data) with the subsequent image processing result data, and displays the generated comparison image data on the display unit. In the present exemplary embodiment, the display control unit 9050 superimposes the preliminary image processing result data on the subsequent image processing result data to generate superimposed image data, which is the comparison image data. Generating the comparison image data is not limited to by superimposition, and a difference between the two image processing result data may be calculated using an exclusive OR or the like.

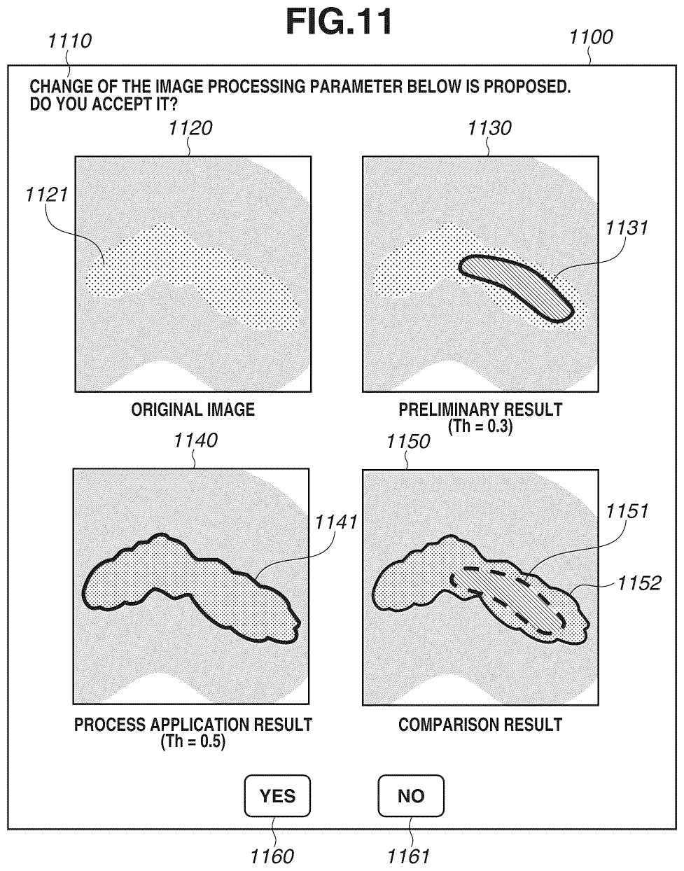

The display control unit 9050 displays each image data on the display unit such as the monitor 205. In addition to the comparison image data, the original image data, the preliminary image processing result data, and the subsequent image processing result data may be displayed side by side. FIG. 11 illustrates an example of display of these image data. An information display window 1100 displayed on the display unit by the display control unit 9050 includes a proposal text 1110, an original image 1120 (original image data), a preliminary result 1130 (preliminary image processing result data), a processing application result 1140 (subsequent image processing result data), a comparison result 1150 (comparison image data), and selection buttons 1160 and 1161. The original image 1120 is CT image data including an organ region 1121.

### Step S10040

In step S10040, the selection information acquisition unit 9070 receives a result of selection by the user. If the user presses the selection button 1160, the selection information acquisition unit 9070 determines that a proposal content based on the information on the image processing candidate has been accepted, and if the user presses the selection button 1161, the selection information acquisition unit 9070 determines that the proposal content has been rejected.

The information processing system 9000 determines the processing details and parameter to be applied based on the user's selection information. If a proposal content based on the information on the image processing candidate is accepted in step S10040, the setting value of the parameter for the image processing corresponding to the information on the image processing candidate is changed to the proposed parameter value. Then, the display control unit 9050 renders the subsequent image processing result data on the monitor 205. If rejected, a message prompting the user to make a re-proposal of the parameter or a message prompting the user to re-enter a text prompt is rendered on the monitor 205. If the user is to re-enter a text prompt, the processing returns to step S3010.

Through the above processing procedure, the information processing system 9000 can identify information on the image processing candidate desired by the user by processing the text prompt indicating the image processing details desired by the user and the information on the image processing algorithm using a generative model.

### Modifications

In the present exemplary embodiment, the example in which the user wants to perform segmentation (image recognition) based on deep learning on image data is described. Alternatively, the user may want to perform image editing or image analysis as the image processing. For example, the image editing can be brightness conversion or smoothing processing, and the image analysis can be calculation of a feature amount.

In the present exemplary embodiment, the user is prompted to make a selection while the images corresponding to respective image processing are displayed. In addition, the parameters used in the respective image processing may also be displayed together. In the present exemplary embodiment, the display control unit 1040 generates a superimposed image by superimposing image data. Alternatively, a difference image may be generated, an image in which images are arranged side by side may be generated, or a feature amount may be calculated based on evaluation indexes instead of images.

The present disclosure can also be realized by processing in which a program that implements one or more functions of the above-described exemplary embodiments is supplied to a system or an apparatus via a network or a storage medium, and one or more processors in a computer of the system or the apparatus read and execute the program. The present disclosure can also be realized by a circuit (e.g., an application specific integrated circuit (ASIC)) that implements one or more functions.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-090550, filed Jun. 4, 2024, which is hereby incorporated by reference herein in its entirety.

What is claimed is:

1. An information processing system that applies an image processing algorithm to image data, comprising:
a memory storing instructions; and
at least one processor configured to execute the instructions to:
acquire input information from a user on the image data and information on the image processing algorithm;
acquire an image processing algorithm corresponding to the input information and an image processing candidate being at least one of parameters constituting the image processing algorithm, by inputting a prompt based on the input information and the information on the image processing algorithm to a generative model based on deep learning; and
display information on the image processing candidate on a display unit.

2. The information processing system according to claim 1, wherein the at least one processor is further configured to acquire selection information on the image processing candidate from the user.

3. The information processing system according to claim 2, wherein the at least one processor is further configured to acquire an acceptance or rejection regarding whether to adopt the image processing candidate displayed on the display unit.

4. The information processing system according to claim 2,
wherein the at least one processor is further configured to acquire information on a plurality of image processing candidates from the generative model, and
wherein the at least one processor is further configured to acquire the selection information from the user with respect to the information on the plurality of image processing candidates.

5. The information processing system according to claim 2,
wherein the at least one processor is further configured to acquire information on a plurality of image processing candidates from the generative model, and
wherein in a case where the image processing candidate displayed on the display unit is not adopted by the user, the at least one processor is further configured to display another image processing candidate among the plurality of image processing candidates on the display unit.

6. The information processing system according to claim 1,
wherein the at least one processor is further configured to further acquire information on preliminary image processing having previously been applied to the image data, and
wherein the at least one processor is further configured to further display the information on the preliminary image processing.

7. The information processing system according to claim 6, wherein the at least one processor is further configured to acquire the image processing candidate by inputting the information on the preliminary image processing to the generative model.

8. The information processing system according to claim 6, wherein the information on the preliminary image processing is information including an image processing algorithm having previously been executed or a parameter of the image processing algorithm having previously been executed.

9. The information processing system according to claim 1, wherein the input information from the user on the image data is text information input by the user or text information selected by the user.

10. The information processing system according to claim 1, wherein the at least one processor is further configured to generate the prompt by using a prompt template.

11. The information processing system according to claim 2, wherein the at least one processor is further configured to execute image processing corresponding to the image processing candidate selected by the user.

12. The information processing system according to claim 1, wherein the at least one processor is further configured to:
acquire first image data, and second image data being image data before preliminary image processing is applied to the first image data; and
generate third image data by applying the image processing candidate to the first image data or the second image data.

13. The information processing system according to claim 12, wherein the at least one processor is further configured to display at least one of the first image data and the second image data, and the third image data in a comparable manner on the display unit.

14. The information processing system according to claim 13, wherein the at least one processor is further configured to generate comparison image data representing a result of comparison between the at least one of the first image data and the second image data, and the third image data, and displays the comparison image data on the display unit.

15. An information processing method for applying an image processing algorithm to image data, the information processing method comprising:
acquiring input information from a user on the image data and information on the image processing algorithm;
acquiring an image processing algorithm corresponding to the input information and an image processing candidate being at least one of parameters constituting the image processing algorithm, by inputting a prompt based on the input information and the information on the image processing algorithm to a generative model based on deep learning; and
displaying information on the image processing candidate on a display unit.

16. A non-transitory storage medium storing a program for causing a computer to execute an information processing method for applying an image processing algorithm to image data, the information processing method comprising:
acquiring input information from a user on the image data and information on the image processing algorithm;
acquiring an image processing algorithm corresponding to the input information and an image processing candidate being at least one of parameters constituting the image processing algorithm, by inputting a prompt based on the input information and the information on the image processing algorithm to a generative model based on deep learning; and
displaying information on the image processing candidate on a display unit.
